(19) United States
(12) Patent Application Publication
(10) Pub. No.: US 2016/0191129 A1
(43) Pub. Date: Jun. 30, 2016

(54) SYSTEM AND METHOD FOR MULTI-USER MULTIPLE POLARIZED INPUT MULTIPLE OUTPUT (MU-MPIMO)

(71) Applicants: Electronics and Telecommunications Research Institute, Daejeon (KR); Industry-University Cooperation Foundation Sunmoon University, Asan-si Chungcheongnam-do (KR)

(72) Inventors: Go San NOH, Daejeon (KR); Seung Jae BAHNG, Daejeon (KR); Jin Up KIM, Daejeon (KR); Youn Ok PARK, Daejeon (KR); Chang Yong SHIN, Asan-si Chungcheongnam-do (KR)

(21) Appl. No.: 14/942,227

(22) Filed: Nov. 16, 2015

(30) Foreign Application Priority Data
Dec. 29, 2014 (KR) 10-2014-0192512

(51) Int. Cl. H04B 7/04; H04B 7/06

(52) U.S. Cl. CPC H04B 7/0469; H04B 7/0452; H04B 7/0617

(57) ABSTRACT

Provided are multiple polarized input multiple output system and method for wireless communication which are capable of simultaneously transmitting respective data streams to a plurality of users by transmitting from multiple polarized input to multiple output in proportion to the number of polarized antennas or the number of polarizations used in a transmitter.

### CROSS-REFERENCE TO RELATED APPLICATIONS

This application claims priority to and the benefit of Korean Patent Application No. 10-2014-0192512 filed in the Korean Intellectual Property Office on Dec. 29, 2014, the entire contents of which are incorporated herein by reference.

### TECHNICAL FIELD

The present invention relates to a system and a method for multiple polarized input multiple output, and more particularly, to a system and a method for multiple polarized input multiple output which are capable of simultaneously transmitting respective data streams to a plurality of users by transmitting from multiple polarized input to multiple output.

### BACKGROUND ART

In an existing system transmitting data by using polarization under a line-of-sight channel environment, even though data are transmitted by installing many polarized antennas in a transmitter or information is transmitted by using a lot of different polarizations, a polarized channel of the system has a degree-of-freedom of 2. In the transmitter for the existing polarized transmission, since respective data streams are transmitted to only maximum of two users regardless of numbers of used polarized antennas and divided polarizations, improvement is required so that respective data streams need to be transmitted to more users.

### SUMMARY OF THE INVENTION

The present invention has been made in an effort to provide a system and a method for multiple polarized input multiple output for wireless communication which may simultaneously transmit respective data streams to a plurality of user by transmitting from multiple polarization input to multiple output in proportion to the number of polarized antennas or the number of polarizations used in a transmitter.

An exemplary embodiment of the present invention provides a transmitter for multiple polarized input multiple output in which respective data streams are transmitted to a plurality of receivers by using multiple polarized signals, the transmitter including: a multiple polarized signal generating unit configured to convert and synthesize N transmission target data streams into N polarized signals; and a radio frequency (RF) unit configured to up-convert and transmit the N synthesized polarized signals through a transmitting antenna.

N receivers may receive different data streams according to the N polarized signals transmitted through one transmitting antenna, respectively.

M multiple polarized signal generating units and M RF units may be included, and MN receivers may receive different data streams according to corresponding MN polarized signals transmitted by the N polarized signals through each of M transmitting antennas, respectively.

The multiple polarized signal generating unit may calculate and code a precoder matrix v⁽ⁱ⁺¹⁾=( [symbol] ⁽ⁱ⁾)⁻¹ with respect to the N polarized signals x=(x₁ x₂ . . . x_{N})^{T}, and here

[symbol]

⁽ⁱ⁾=(H₁^{T}(w₁⁽ⁱ⁾)*H₂^{T}(w₂⁽ⁱ⁾)* . . . H_{N}^{T}(w_{N}⁽ⁱ⁾)*)^{T}

H₁, H₂, . . . , H_{N} may be a channel matrix including line-of-sight and non-line-of-sight channel components with respect to each channel of the N polarized signals, and ω₁⁽ⁱ⁾, ω₂⁽ⁱ⁾, . . . , ω_{N}⁽ⁱ⁾ may be a receiving signal combiner column vector having an i-th repeating number with respect to each channel of the N polarized signals.

The precoder matrix may be calculated by various techniques including the zero-forcing (ZF) method and the minimum mean square error (MMSE) method.

The multiple polarized signal generating unit may repeatedly calculate the precoder matrix until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here

$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$

Hₘ may be a channel matrix for the receiver m, vₘ⁽ⁱ⁺¹⁾ may be an m-th column of an i+1-th precoder matrix V⁽ⁱ⁺¹⁾, ( )* may be a conjugate complex number, and ∥ ∥₂ may be the magnitude of the vector.

The receiving signal combiner column vector may be calculated by various receiver diversity combing techniques including the maximal ratio combining (MRC) method, the equal gain combining (EGC) method, the selection combining method, and the switched combining method.

When the M multiple polarized signal generating units and the M RF units are included, each multiple polarized signal generating unit may calculate and code a precoder matrix v⁽ⁱ⁺¹⁾=( [symbol] ⁽ⁱ⁾)⁻¹ with respect to the corresponding MN polarized signals x=(x₁⁽¹⁾x₂⁽¹⁾ . . . x_{N}⁽¹⁾ . . . x₁^{(M)}x₂^{(M)} . . . x_{N}^{(M)})^{T}, and here

[symbol]

⁽ⁱ⁾=( [symbol] ₁^{T}(w₁⁽ⁱ⁾)* [symbol] ₂^{T}(w₂⁽ⁱ⁾)* . . . [symbol] _{MN}^{T}(w_{MN}⁽ⁱ⁾)*)^{T},

[symbol] ₁, [symbol] ₂, . . . , [symbol] _{MN} may be a channel matrix including line-of-sight and non-line-of-sight channel components with respect to each channel of the MN polarized signals, and ω₁⁽ⁱ⁾, ω₂⁽ⁱ⁾, . . . , ω_{MN}⁽ⁱ⁾ may be a receiving signal combiner column vector having a i-th repeating number with respect to each channel of the MN polarized signals.

The precoder matrix may be calculated by various techniques including the zero-forcing (ZF) method and the minimum mean square error (MMSE) method.

The precoder matrix may be repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here

$${w}_{m}^{( i + 1 )} = \frac{{( {ℍ}_{m} {v}_{m}^{( i + 1 )} )}^{*}}{{‖ {ℍ}_{m} {v}_{m}^{( i + 1 )} ‖}_{2}} ,$$

[symbol] ₘ may be a channel matrix for the receiver m, vₘ⁽ⁱ⁺¹⁾ may be an m-th column of an i+1-th precoder matrix V⁽ⁱ⁺¹⁾, ( )* may be a conjugate complex number, and ∥ ∥₂ may be the magnitude of the vector.

The receiving signal combiner column vector may be calculated by various receiver diversity combing techniques including the maximal ratio combining (MRC) method, the equal gain combining (EGC) method, the selection combining method, and the switched combining method.

Another exemplary embodiment of the present invention provides a multiple polarized input multiple output method in which respective data streams are transmitted to a plurality of receivers by using multiple polarized signals in a transmitter, the method including: converting and synthesizing N transmission target data streams into N polarized signals; and up-converting and transmitting the N synthesized polarized signals through a transmitting antenna.

N receivers may receive different data streams according to the N polarized signals transmitted through one transmitting antenna, respectively.

MN receivers may receive different data streams according to corresponding MN polarized signals transmitted by the N polarized signals through each of the M transmitting antennas, respectively.

In the converting and synthesizing step, a precoder matrix v⁽ⁱ⁺¹⁾=( [symbol] ⁽ⁱ⁾)⁻¹ may be calculated and coded with respect to the N polarized signals x=(x₁ x₂ . . . x_{N})^{T}, and here)

[symbol]

⁽ⁱ⁾=H₁^{T}(w₁⁽ⁱ⁾)*H₂^{T}(w₂⁽ⁱ⁾)* . . . H_{N}^{T}(w_{N}⁽ⁱ⁾)*)^{T}

H₁, H₂, . . . , H_{N} may be a channel matrix including line-of-sight and non-line-of-sight channel components with respect to each channel of the N polarized signals, and ω₁⁽ⁱ⁾, ω₂⁽ⁱ⁾, . . . , ω_{N}⁽ⁱ⁾ may be a receiving signal combiner column vector having an i-th repeating number with respect to each channel of the N polarized signals.

The precoder matrix may be repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here

$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$

Hₘ may be a channel matrix for the receiver m, vₘ⁽ⁱ⁺¹⁾ may be an m-th column of an i+1-th precoder matrix V⁽ⁱ⁺¹⁾, ( )* may be a conjugate complex number, and ∥ ∥₂ may be the magnitude of the vector.

In order to transmit a total of MN polarized signals by the N polarized signals through the M transmitting antennas, in the converting and synthesizing step, a precoder matrix v⁽ⁱ⁺¹⁾=( [symbol] ⁽ⁱ⁾)⁻¹ may be calculated and coded with respect to the corresponding MN polarized signals x=(x₁⁽¹⁾x₂⁽¹⁾ . . . x_{N}⁽¹⁾ . . . x₁^{(M)}x₂^{(M)} . . . x_{N}^{(M)})^{T}, and here,

[symbol]

⁽ⁱ⁾=( [symbol] ₁^{T}(w₁⁽ⁱ⁾)* [symbol] ₂^{T}(w₂⁽ⁱ⁾)* . . . [symbol] _{MN}^{T}(w_{MN}⁽ⁱ⁾)*)^{T},

[symbol] ₁, [symbol] ₂, . . . , [symbol] _{MN} may be a channel matrix including line-of-sight and non-line-of-sight channel components with respect to each channel of the MN polarized signals, and ω₁⁽ⁱ⁾, ω₂⁽ⁱ⁾, . . . , ω_{MN}⁽ⁱ⁾ may be a receiving signal combiner column vector having an i-th repeating number with respect to each channel of the MN polarized signals.

The precoder matrix may be repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here

$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$

[symbol] ₘ may be a channel matrix for the receiver m, vₘ⁽ⁱ⁺¹⁾ may be an m-th column of an i+1-th precoder matrix V⁽ⁱ⁺¹⁾, ( )* may be a conjugate complex number, and ∥ ∥₂ may be the magnitude of the vector.

According to a system and a method for multiple polarized input multiple output for wireless communication of the present invention, the transmitter may simultaneously transmit any number of different polarized signals without performance deterioration in a multi-user environment. Therefore, it is possible to significantly improve a total of transmission capacity of a wireless communication system. That is, when the transmitter of the present invention transmits N different polarized signals by using respective antennas, a total of transmission capacity may be increased by N times as compared with an existing system. Further, the number N of used polarizations may be arbitrarily increased according to a design.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for describing a multiple polarized single antenna system for transmission to multi-users according to an exemplary embodiment of the present invention.

FIG. 2A is a configuration diagram of a transmitter of FIG. 1.

FIG. 2B is a configuration diagram of a receiver of FIG. 1.

FIG. 2C is a flowchart for describing an operation of the multiple polarized single antenna system of FIG. 1.

FIG. 3 is a graph for a performance example of a total transmission rate while using four polarizations in the multiple polarized single antenna system of FIG. 1.

FIG. 4 is a diagram for describing a multiple polarized multiple antenna system for transmission to multi-users according to another exemplary embodiment of the present invention.

FIG. 5A is a configuration diagram of a transmitter of FIG. 4.

FIG. 5B is a configuration diagram of a receiver of FIG. 4.

FIG. 5C is a flowchart for describing an operation of the multiple polarized multiple antenna system of FIG. 4.

FIG. 6 is an exemplary diagram for transmission to four users in the multiple polarized multiple antenna system of FIG. 4.

FIG. 7 is a graph for a performance example of a total transmission rate in the multiple polarized multiple antenna system of FIG. 6.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described in priority and a description of elements which may obscure the gist of the present invention will be skipped. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

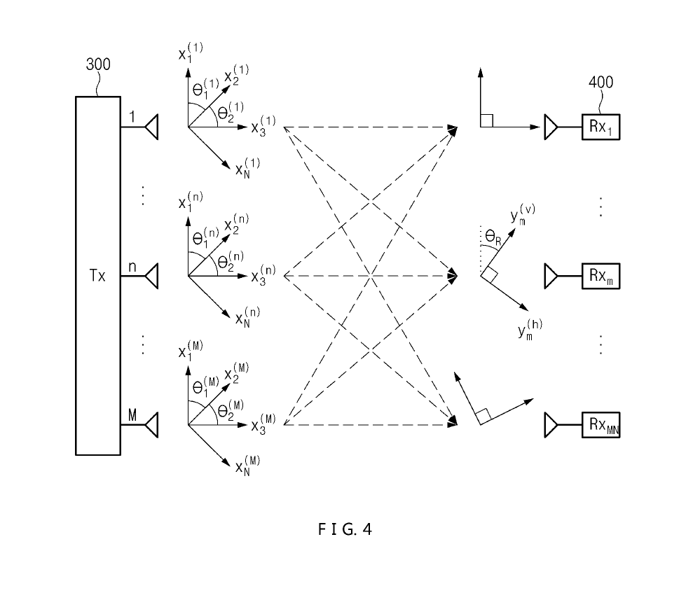

In the present invention, a multiple polarized single antenna system (see FIGS. 1 to 3) and a multiple polarized multi-antenna system (see FIGS. 4 to 7), which simultaneously transmits respective data streams to respective wireless communication receivers to a plurality of users through a single antenna or multiple antennas which may transmit multiple polarized signals in a transmitter for wireless communication, will be described

In the present invention, a multiple polarized signal may be a signal for wireless mobile communication according to a protocol such as WCDMA and LTE, and further, in some cases, may be a signal for wireless local-area communication such as WiFi, Bluetooth, and Zigbee and may be extended and applied even to a signal for another wireless communication

Accordingly, hereinafter, the transmitter or the receiver may be a transmitter or a receiver which is installed on a base station, an access point (AC), a mobile terminal such as a mobile phone, and the like for wireless communication such as wireless mobile communication and wireless local-area communication

First, FIG. 1 is a diagram for describing a multiple polarized single antenna system for transmission to multi-users according to an exemplary embodiment of the present invention.

Referring to FIG. 1, the multiple polarized single antenna system according to the exemplary embodiment of the present invention includes a transmitter 100 transmitting N (N is a natural number) polarized signals by using one transmission antenna and a receiver 200 receiving polarized signals transmitted in the transmission antenna by using one dual-polarized antenna. The receiver 200 includes N receivers RX₁, RX₂, . . . , RX_{N}, and the transmitter 100 may simultaneously transmit respective data streams to N receivers RX₁, RX₂, . . . , RX_{N} by using N polarized signals, respectively

Hereinafter, for describing a transmission scheme of the present invention, a scenario which transmits one data stream through one polarized signal per user to each of the N receivers RX₁, RX₂, . . . , RX_{N}, of maximum N users is described, but the present invention is not limited thereto. The scenario may be extended by a scheme of transmitting two data streams divided through two different polarizations to each user's receiver according to a configuration of the receiver.

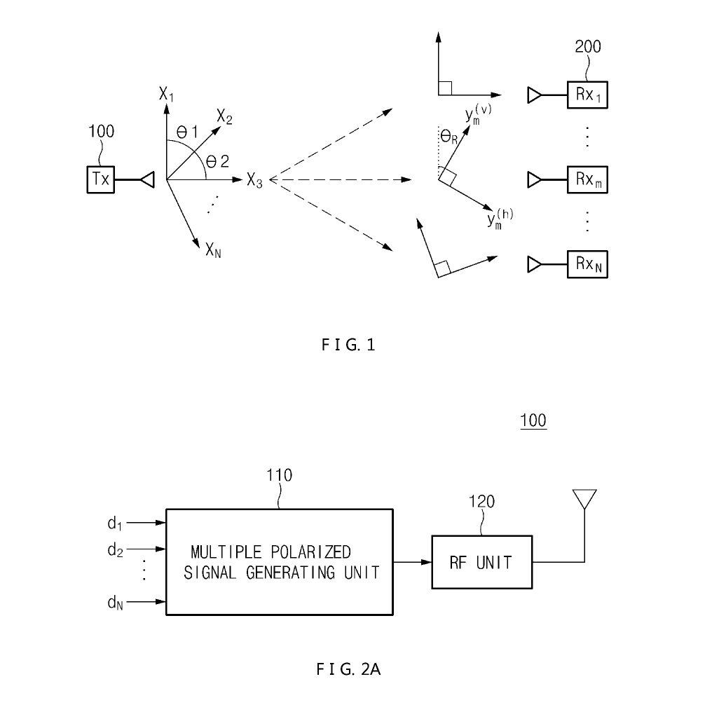

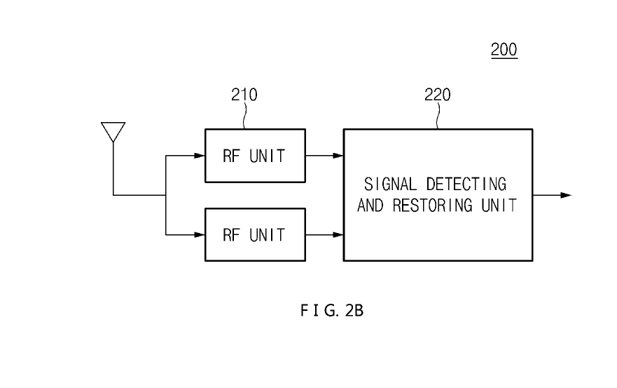

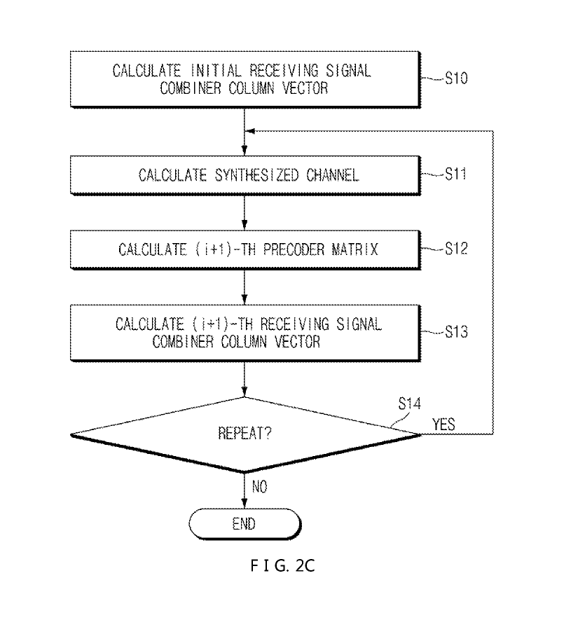

FIG. 2A is a configuration diagram of the transmitter 100 of FIG. 1. FIG. 2B is a configuration diagram of the receiver 200 of FIG. 1. As illustrated in FIG. 2A, the transmitter 100 includes a multiple polarized signal generating unit 110 and a radio frequency (RF) unit 120, and as illustrated in FIG. 2B, each receiver 200 includes an RF unit 210 and a signal detecting and restoring unit 220. The RF unit 210 may be configured by two or more RF units for processing two or more different polarizations in order to receive two or more divided data streams

In the transmitter 100, the multiple polarized signal generating unit 110 converts and synthesizes N transmission target data streams d₁, d₂, . . . , d_{N} into N polarized signals x₁, x₂, . . . , x_{N} in a base band corresponding to the transmission target data streams. The N polarized signals x₁, x₂, . . . , x_{N} form N channels having transmission polarized angles of θ₁, θ₂, . . . , θ_{N} between adjacent signals according to a predetermined algorithm. The RF unit 120 up-converts the signals synthesized in the multiple polarized signal generating unit 110 to transmit the up-converted signals through one transmission antenna

In the receiver 200, each RF unit 210 (for example, m-th RXₘ) receives a signal (for example, a signal having a reception polarized angle θ_{R} in a receiver-side coordinate yₘ^{(v)} and yₘ^{(h)})) of the corresponding channel for each data stream transmitted in the transmitter 100 through one dual-polarization antenna and down-converts the received signal into a signal in a base band. The signal detecting and restoring unit 220 estimates and restores the corresponding original data stream from an output of each RF unit 210

A substantial line-of-sight channel environment between the transmitter 100 and the receiver 200 generally includes a non-line-of-sight channel component slightly even if a line-of-sight channel component is significantly large. Accordingly, as described below, a Rician channel model and a K factor value of the model are appropriately controlled to express a line-of-sight channel environment well by a matrix Hₘ of 2×N channels in an m-th receiver RXₘ like Equation 1.

$${H}_{m} = \sqrt{\frac{K}{K + 1}} {\overline{H}}_{m} + \sqrt{\frac{1}{K + 1}} {\tilde{H}}_{m} \qquad [ Equation 1 ]$$

Here, H̅ₘ is a matrix of 2×N line-of-sight channel components to an m-th receiver RXₘ antenna from the antenna of the transmitter 100, and \tilde{H}ₘ represents a matrix of 2×N non-line-of-sight channel components to an m-th receiver RXₘ antenna from the antenna of the transmitter 100. Further, K is a parameter determining the magnitude of line-of-sight channel component power

H̅ₘ which is the line-of-sight channel component is expressed like Equation 2 based on a parameter given in FIG. 1

$${\overline{H}}_{m} = ( \begin{matrix}cos ( {θ}_{1} - {θ}_{R} ) cos ( {θ}_{1} + {θ}_{2} - {θ}_{R} ) … cos ( {\sum }_{k = 1}^{N} {θ}_{K} - {θ}_{R} ) \\ sin ( {θ}_{1} - {θ}_{R} ) sin ( {θ}_{1} + {θ}_{2} - {θ}_{R} ) … sin ( {\sum }_{k = 1}^{N} {θ}_{K} - {θ}_{R} )\end{matrix} ) \qquad [ Equation 2 ]$$

\tilde{H}ₘ which is the non-line-of-sight channel component may not be represented as a fixed value but may be represented as a statistical characteristic. A channel correlation matrix R=E{vec( [symbol] )vec( [symbol] )^{H}} which is a statistical mean (E) characteristic of the non-line-of-sight channel component may be simply approximated like Equation 3 by considering an angle, reflection and scattering characteristics, and the like of the polarized signal. In this case, a matrix [symbol] means [symbol] =(\tilde{H}₁^{T}\tilde{H}₂^{T} . . . \tilde{H}_{N}^{T})^{T}. T is a function which changes rows and columns as a transpose.

$$R = ( \begin{matrix}{I}_{0} & ρ {I}_{- {θ}_{2}} & … & ρ I - {\sum }_{k = 2}^{N - 1} {θ}_{K} & ρ I - {\sum }_{k = 2}^{N} {θ}_{K} \\ ρ {I}_{{θ}_{2}} & {I}_{0} & … & ρ I - {\sum }_{k = 3}^{N - 1} {θ}_{K} & ρ I - {\sum }_{k = 3}^{N} {θ}_{K} \\ ⋮ & ⋮ & ⋱ & ⋮ & ⋮ \\ ρ I {\sum }_{k = 2}^{N - 1} {θ}_{K} & ρ I {\sum }_{k = 3}^{N - 1} {θ}_{K} & … & {I}_{0} & ρ {I}_{- {θ}_{N}} \\ ρ I {\sum }_{k = 2}^{N - 1} {θ}_{K} & ρ I {\sum }_{k = 3}^{N - 1} {θ}_{K} & … & ρ {I}_{{θ}_{N}} & {I}_{0}\end{matrix} ) \qquad [ Equation 3 ]$$

Here, I_{θ} is given like Equation 4, and ρ is a constant number representing a channel correlation of the non-line-of-sight channel component satisfying 0≦ρ≦1.

$${I}_{θ} = ( \begin{matrix}cos θ & - sin θ \\ sin θ & cos θ\end{matrix} ) \qquad [ Equation 4 ]$$

Meanwhile, in FIG. 1, a receiving signal yₘ of the m-th receiver RXₘ may be represented like Equation 5. Here, x=(x₁ x₂ . . . x_{N})^{T} is a vector of a transmission target polarized signal, and zₘ is a white Gaussian noise vector in the m-th receiver.

yₘ=(yₘ^{(v)}yₘ^{(h)})^{T}=Hₘx+zₘ [Equation 5]

Meanwhile, the multiple polarized signal generating unit 110 of the transmitter 100 performs precoding through a precoder with respect to N polarized signals x₁, x₂, . . . , x_{N} according to channel state information (for example, a corresponding channel identifier corresponding to the polarized signals x₁, x₂, . . . , x_{N}) of the polarized signal which is fed-back from N receivers RX₁, RX₂, . . . , RX_{N} and may send each desired data stream of each receiver RX₁, RX₂, . . . , RX_{N} without interference by transmitting the transmission target data streams which are encoded by the predetermined encoder. Further, each receiver RX₁, RX₂, . . . , RX_{N} maximizes receiving signal quality by applying various receiving signal combining schemes such as maximal ratio combining to the signal received through each polarization of the receiving antenna.

Accordingly, things which need to be determined by the transmitter 100 and the m-th receiver Rₓₘ of FIG. 1 are a N×N precoder matrix V and a 2×1 signal combiner column vector ωₘ. When the antenna of the transmitter 100 transmits any N polarized signals, the precoder matrix of the transmitter 100 and the signal combiner column vector of the receiver 200 may be calculated by using a next repeatedly performed procedure in the multiple polarized signal generating unit 110 of the transmitter 100. Here, a flowchart of FIG. 2C will be referred

First, an initial receiving signal combiner column vector ωₘ^{(o)} is calculated like Equation 6 by setting i representing a repeating number as 0 and allocating any matrix to an initial precoder matrix V⁽⁰⁾ (S10).

$${w}_{m}^{( 0 )} = \frac{{( {H}_{m} {v}_{m}^{( 0 )} )}^{*}}{{‖ {H}_{m} {v}_{m}^{( 0 )} ‖}_{2}} \qquad [ Equation 6 ]$$

Here, vₘ⁽⁰⁾ means an m-th column of an i-th precoder matrix V⁽ⁱ⁾, ( )* means a conjugate complex number, and ∥ ∥₂ means the magnitude of the vector. Next, a synthesized channel [symbol] ⁽ⁱ⁾ is calculated like Equation 7 (S11).

[symbol]

⁽ⁱ⁾=(H₁^{T}(w₁⁽ⁱ⁾)*H₂^{T}(w₂⁽ⁱ⁾)* . . . H_{N}^{T}(w_{N}⁽ⁱ⁾)*)^{T} [Equation 7]

Next, an (i+1)-th precoder matrix V⁽ⁱ⁺¹⁾ is calculated by using various methods such as zero-forcing (ZF) beam formation or minimum mean square error (MMSE) beam formation methods (S12). For example, in the case of applying the zero-forcing beam formation method, the (i+1)-th precoder matrix V⁽ⁱ⁺¹⁾ is given like Equation 8.

v⁽ⁱ⁺¹⁾=( [symbol] ⁽ⁱ⁾)⁻¹

Next, an (i+1)-th receiving signal combiner column vector ωₘ⁽ⁱ⁺¹⁾ may be calculated by various receiver diversity combing techniques including the maximal ratio combining (MRC) method, the equal gain combining (EGC) method, the selection combining method, and the switched combining method (S13). For example, in the case of calculating the (i+1)-th receiving signal combiner column vector according to the maximal ratio combining scheme, the Equation 9 is given.

$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} , \qquad [ Equation 9 ]$$

Finally, if the repeating number i exceeds a predetermined number or satisfies ∥ωₘ⁽ⁱ⁺¹⁾−ωₘ⁽ⁱ⁾∥₂<ε according to a predetermined error value ε, an algorithm ends, and if not, the step returns to the step S11 by increasing the repeating number by 1 and the performance is repeated to satisfy the condition (S14)

The algorithm is performed in the multiple polarized signal generating unit 110 of the transmitter 100 to determine the precoder matrix V of the transmitter 100. On the contrary, the receiver 200 may restore the data by acquiring channel information based on a pilot signal transmitted through the precoder determined in the transmitter 100 without performing the algorithm to calculate the signal combiner column vector like the above process.

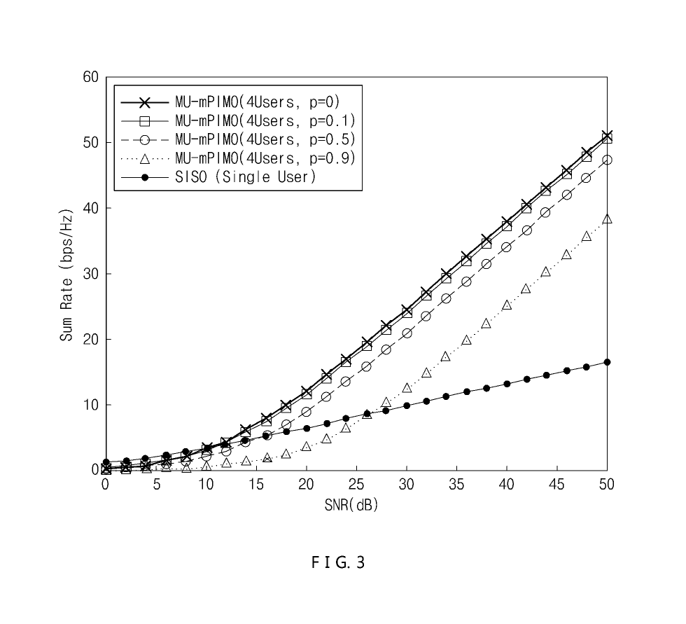

FIG. 3 is a graph for a performance example of a total transmission rate while using four polarizations in the multiple polarized single antenna system of FIG. 1.

In FIG. 3, in the case where the transmitter 100 transmits respective data streams to respective receivers of four users by using four polarizations, when all of the angles θ₁, θ₂, θ₃, and θ₄ of the four polarizations are the same as 45° and the line-of-sight channel component occupies about 90.9% (K=10), total transmission rate performance Sum Rate (bps/Hz) according to a ρ value which represents a channel correlation of the non-line-of-sight channel component given in Equation 3 is illustrated. In this case, the precoder matrix of the transmitter 100 is calculated by using a zero-forcing beamforming (ZF-BF) method and the receiving signal combiner column vector of the receiver 200 is acquired through the maximal ratio combining method.

As illustrated in FIG. 3, it can be seen that the multiple polarized input multiple output method for simultaneous transmission of multiple users of the present invention acquires degree-of-freedom (DoF) performance of 4 which is the same as the number of used polarizations to simultaneously transmit the respective data streams to four users without deterioration of the performance in a region having a high signal to noise ratio (SNR). Further, it can be seen that the system of the present invention achieves a much higher total transmission rate than a single input single output (SISO) system in which the data streams are transmitted to a single user by using a single polarization in the related art.

FIG. 4 is a diagram for describing a multiple polarized multiple antenna system for transmission to multi-users according to another exemplary embodiment of the present invention

Referring to FIG. 4, the multiple polarized multiple antenna system according to another exemplary embodiment of the present invention includes a transmitter 300 transmitting N (N is a natural number) polarized signals by using M (M is a natural number) transmission antennas and a receiver 400 receiving polarized signals transmitted in the transmission antennas by using one dual-polarized antenna. The receiver 400 includes MN receivers RX₁, RX₂, . . . , RX_{MN}, and the transmitter 300 may simultaneously transmit respective data streams to MN receivers RX₁, RX₂, . . . , RX_{MN} by using MN polarized signals, respectively. FIG. 4 illustrates an example of a system of simultaneously transmitting respective data streams to MN multiple users through M (M is a natural number) antennas which may transmit multiple polarized signals in the transmitter 300.

Herein, for describing a transmission scheme of the present invention, a scenario which transmits one data stream through one polarized signal per user to each of the MN receivers RX₁, RX₂, . . . , RX_{N} of the maximum MN users is described, but the present invention is not limited thereto. The scenario may be extended by a scheme of transmitting two data streams divided through two different polarizations to each user's receiver according to a configuration of the receiver.

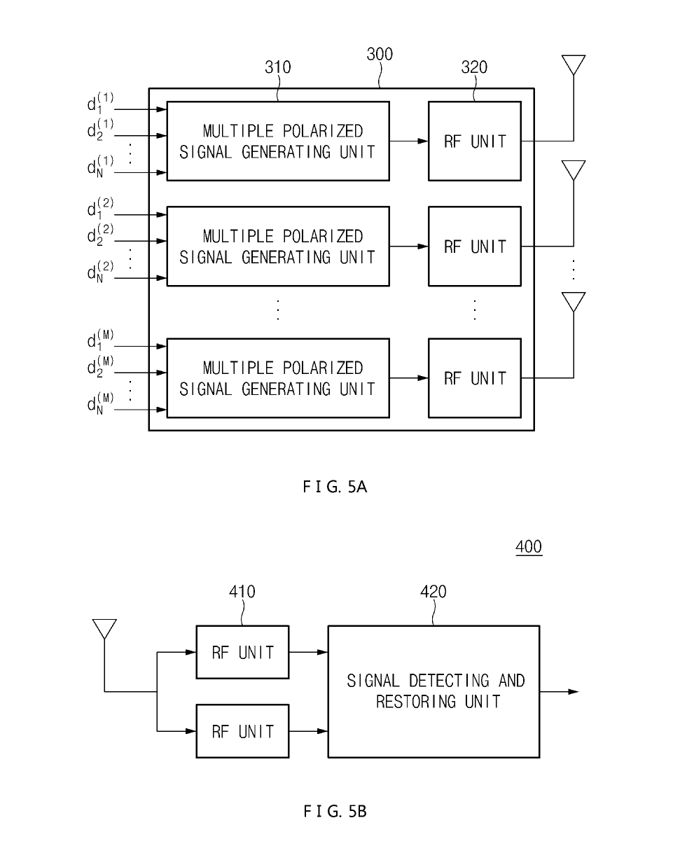

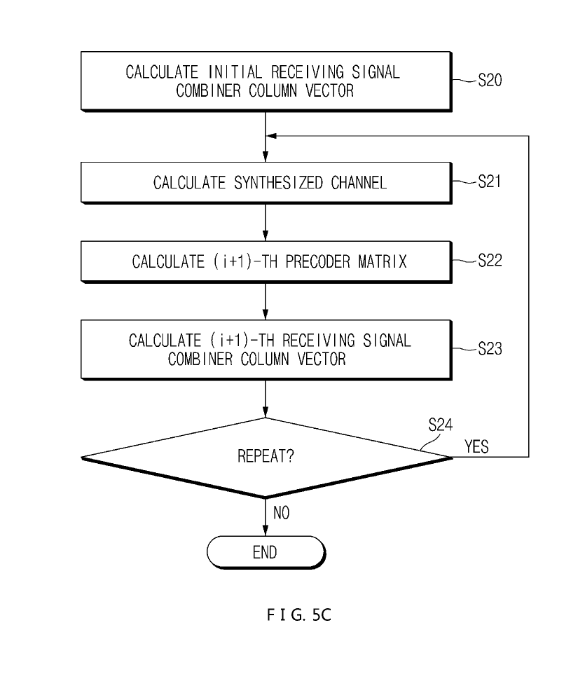

FIG. 5A is a configuration diagram of the transmitter 300 of FIG. 4. FIG. 5B is a configuration diagram of the receiver 400 of FIG. 4. As illustrated in FIG. 5A, the transmitter 300 includes a multiple polarized signal generating unit 310 and an RF unit 320 in each of the M transmission modules which transmit N polarized signals, and as illustrated in FIG. 5B, each receiver 400 includes an RF unit 410 and a signal detecting and restoring unit 420. The RF unit 210 may be configured by two or more RF units for processing two or more different polarizations in order to receive two or more divided data streams

In the transmitter 300, each multiple polarized signal generating unit 310 converts and synthesizes N transmission target data streams (for example, d₁⁽¹⁾, d₂⁽¹⁾, . . . , d_{N}⁽¹⁾) into N polarized signals (for example, x₁⁽¹⁾, x₂⁽¹⁾, . . . , x_{N}⁽¹⁾) in a base band corresponding to the data streams. The N polarized signals (for example, x₁⁽¹⁾, x₂⁽¹⁾, . . . , x_{N}⁽¹⁾) form N channels having transmission polarized angles of θ₁⁽¹⁾, θ₂⁽¹⁾, . . . , θ_{N}⁽¹⁾ between the adjacent signals according to a predetermined algorithm. Each RF unit 320 up-converts the signals synthesized in the multiple polarized signal generating unit 310 to transmit the up-converted signals through one transmission antenna

In the receiver 400, each RF unit 410 (for example, m-th RXₘ) receives a signal (for example, a signal having a reception polarized angle θ_{R} in a receiver-side coordinate yₘ^{(v)} and yₘ^{(h)})) for each data stream transmitted in the transmitter 300 through one dual-polarization antenna and down-converts the received signal into the signal in the base band. The signal detecting and restoring unit 420 estimates and restores the corresponding original data stream from an output of each RF unit 410

A substantial line-of-sight channel environment between the transmitter 300 and the receiver 400 generally includes a non-line-of-sight channel component slightly even if a line-of-sight channel component is significantly large. Accordingly, as described below, a Rician channel model and a K factor value of the model are appropriately controlled to express the line-of-sight channel environment well by a channel matrix Hₘ in the m-th receiver RXₘ like Equation 1.

Here, when the 2×N channel matrix between the n-th transmitting antenna and the m-th receiver RXₘ antenna of FIG. 4 is represented by Hₘₙ and the Rician channel model is considered like Equation 10, the matrix H̅ₘₙ expressing the line-of-sight channel component may be configured by considering the transmitting polarized angle and the receiving polarized angle by the same method as the multiple polarized single antenna system described above.

$${H}_{mn} = \sqrt{\frac{K}{K + 1}} {\overline{H}}_{mn} + \sqrt{\frac{1}{K + 1}} {\tilde{H}}_{mn} \qquad [ Equation 10 ]$$

In the case of the non-line-of-sight channel component, the matrix \tilde{H}ₘₙ may be represented by a statistical characteristic instead of the fixed channel value. A channel correlation matrix R=E{vec( [symbol] )vec( [symbol] )^{H}} which is a statistical characteristic of the non-line-of-sight channel component may be calculated by considering both a correlation between channels generated by the polarization transmitted in the single transmission antenna which is calculated in the multiple polarized single antenna system by considering an angle, reflection and scattering characteristics, and the like of the polarized signal and a channel correlation between the transmitting antennas. Here, [symbol] =( [symbol] ₁^{T} [symbol] ₂^{T} . . . [symbol] _{MN}^{T})^{T} and [symbol] ₘ=(\tilde{H}ₘ₁\tilde{H}ₘ₂ . . . \tilde{H}_{mM}). Further, when [symbol] ₘ=(Hₘ₁ Hₘ₂ . . . H_{mM}), in FIG. 4, the receiving signal yₘ of the m-th receiver RXₘ is represented as Equation 11.

yₘ=(yₘ^{(v)}yₘ^{(h)})^{T}= [symbol] ₘx+zₘ [Equation 11]

In this case, x=(x₁⁽¹⁾x₂⁽¹⁾ . . . x_{N}⁽¹⁾ . . . x₁^{(M)}x₂^{(M)} . . . x_{N}^{(M)})^{T} is a transmission signal vector, and zₘ means a white Gaussian noise vector in the m-th receiver RXₘ.

In the system of FIG. 4, the transmitter 300 determines a precoder based on the channel state information (for example, a channel identifier and the like) of the polarized signal fed-back from the MN receivers RX₁, RX₂, . . . , RX_{MN} to transmit the information through the precoder, and as a result, each receiver RX₁, RX₂, . . . , RX_{MN} may receive its own desired data without interference. Further, each receiver RX₁, RX₂, . . . , RX_{MN} maximizes receiving signal quality by applying various receiving signal combining schemes such as a maximal ratio combining scheme to the signal received through each polarization of the receiving antenna

Accordingly, in FIG. 4, things which need to be determined by the transmitter 300 and the m-th receiver RXₘ are a MN×MN precoder matrix V and a 2×1 signal combiner column vector ωₘ. When the information is transmitted by using any M transmitting antennas and N polarized signals per the transmitting antenna, the precoder matrix of the transmitter and the signal combiner column vector of the receiver may be calculated by using a next repeatedly performed procedure in the multiple polarized signal generating unit 110 like the operation method of the multiple polarized single antenna system described above. Here, a flowchart of FIG. 5C will be referred

First, an initial receiving signal combiner column vector ωₘ⁽⁰⁾ is calculated like Equation 12 by setting i representing a repeating number as 0 and allocating any matrix to an initial precoder matrix V⁽⁰⁾ (S20).

$${w}_{m}^{( 0 )} = \frac{{( {H}_{m} {v}_{m}^{( 0 )} )}^{*}}{{‖ {H}_{m} {v}_{m}^{( 0 )} ‖}_{2}} \qquad [ Equation 12 ]$$

Here, vₘ⁽ⁱ⁾ is means an m-th column of an i-th precoder matrix V⁽ⁱ⁾, ( )* means a conjugate complex number, and ∥ ∥₂ means the magnitude of the vector.

Next, a synthesized channel [symbol] ⁽ⁱ⁾ is calculated like Equation 13 (S21).

[symbol]

⁽ⁱ⁾=( [symbol] ₁^{T}(w₁⁽ⁱ⁾)* [symbol] ₂^{T}(w₂⁽ⁱ⁾)* . . . [symbol] _{MN}^{T}(w_{MN}⁽ⁱ⁾)*)^{T} [Equation 13]

Next, an (i+1)-th precoder matrix V⁽ⁱ⁺¹⁾ is calculated by using various methods such as zero-forcing (ZF) beam formation or minimum mean square error (MMSE) beam formation methods (S22). For example, in the case of applying the zero-forcing beam formation method, the (i+1)-th precoder matrix V⁽ⁱ⁺¹⁾ is given like Equation 14.

v⁽ⁱ⁺¹⁾=( [symbol] ⁽ⁱ⁾)⁻¹ [Equation 14]

Next, an (i+1)-th receiving signal combiner column vector ωₘ⁽ⁱ⁺¹⁾ may be calculated by various receiver diversity combing techniques including the maximal ratio combining (MRC) method, the equal gain combining (EGC) method, the selection combining method, and the switched combining method (S23). For example, in the case of calculating the (i+1)-th receiving signal combiner column vector according to the maximal ratio combining scheme, the Equation 15 is given.

$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} \qquad [ Equation 15 ]$$

Finally, if the repeating number i exceeds a predetermined number or satisfies ∥ωₘ⁽ⁱ⁺¹⁾−ωₘ⁽ⁱ⁾∥₂<ε according to a predetermined error value ε, an algorithm ends, and if not, the step returns to the step S21 by increasing the repeating number by 1 and the performance is repeated to satisfy the condition (S24)

The algorithm is performed in the multiple polarized signal generating unit 310 of the transmitter 300 to determine the precoder matrix V of the transmitter 300. On the contrary, the receiver 400 may restore the data by acquiring channel state information based on a pilot signal transmitted through the precoder determined in the transmitter 300 without performing the algorithm to calculate the signal combiner column vector through the above process.

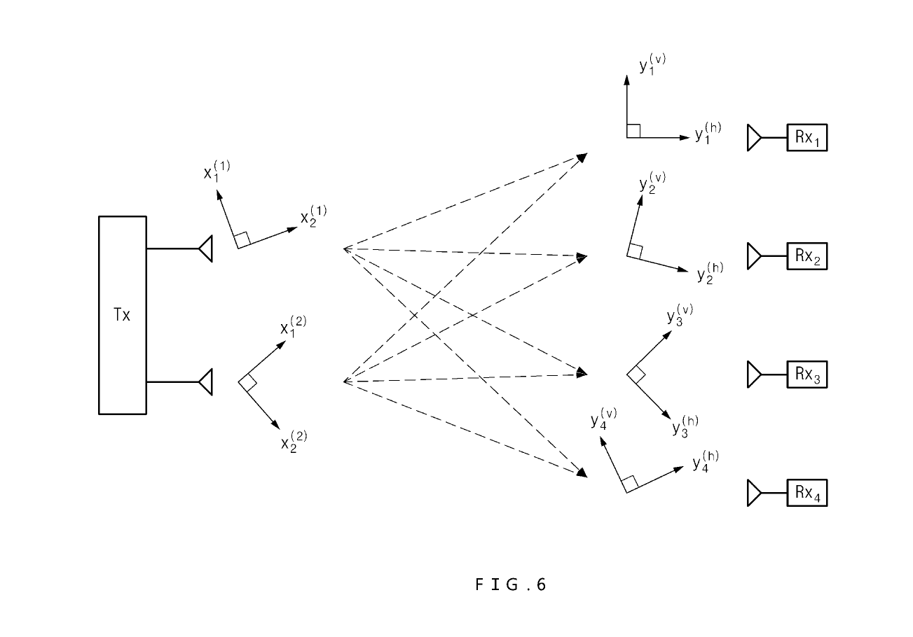

FIG. 6 is an exemplary diagram for transmission to four users in the multiple polarized multiple antenna system of FIG. 4.

The system of FIG. 6 is a case where M=2 and N=2 in FIG. 4, that is, a case where transmitting antennas of the transmitter 300 are two (M=2) and respective data streams are transmitted to respective receivers of four users by using two polarizations (N=2, dual-polarization) per transmitting antenna. In this case, in the respective transmitting antennas, the polarizations which are orthogonal to each other are used and the line-of-sight channel component occupies about 90.9% (K=10)

A correlation between the channels generated by polarizations transmitted in the respective transmitting antennas follows Equation 3 by considering a statistical characteristic of the non-line-of-sight channel component and the distance between the transmitting antennas and the distance between the receivers are sufficiently far away, and as a result, it is considered that there are no correlation between the channels from different transmitting antennas to each receiving antenna and no correlation between the channels from each transmitting antenna to different receiving antennas. That is, when k≠m or l≠n, E{vec(Hₖₗ)vec(Hₘₙ)^{H}}=0.

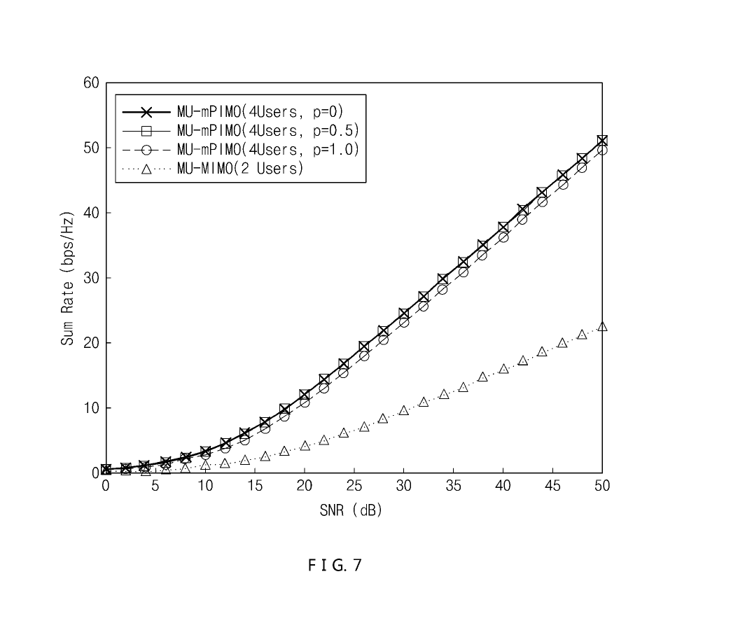

In the system environment, an example for a graph of total transmission rate performance according to a ρ value representing the channel correlation of the non-line-of-sight channel component given in Equation 3 is illustrated in FIG. 7. Here, the precoder matrix of the transmitter 300 is calculated by using a zero-forcing beamforming (ZF-BF) method and the receiving signal combiner column vector of the receiver is acquired through the maximal ratio combining method.

As illustrated in FIG. 7, the method of the present invention acquires DoF performance of 4 which is the same as a multiple of the number (M=2) of transmitting antennas used in a high SNR region and the number (N=2) of polarizations per transmitting antenna to simultaneously transmit the respective data streams to all of four users without deterioration of the performance. Further, it can be seen that the system of the present invention achieves a much higher total transmission rate than the multi-user multiple input multiple output (MU-MIMO) system in which the data streams are transmitted to two users by using a single polarization in existing two transmitting antennas.

The present invention has been described by the specified matters such as specific components and limited exemplary embodiments and drawings, which are provided to help the overall understanding of the present invention and the present invention is not limited to the exemplary embodiments, and those skilled in the art will appreciate that various modifications and changes can be made within the scope without departing from an essential characteristic of the present invention. The spirit of the present invention is defined by the appended claims rather than by the description preceding them, and the claims to be described below and it should be appreciated that all technical spirit which are evenly or equivalently modified are included in the claims of the present invention.

What is claimed is:

1. A transmitter for multiple polarized transmission in which respective data streams are transmitted to a plurality of receivers by using multiple polarized signals, the transmitter comprising:
a multiple polarized signal generating unit configured to convert and synthesize N transmission target data streams into N polarized signals; and
a radio frequency (RF) unit configured to up-convert and transmit the N synthesized polarized signals through a transmitting antenna.

2. The transmitter of claim 1, wherein N receivers receive different data streams according to the N polarized signals transmitted through one transmitting antenna, respectively.

3. The transmitter of claim 1, wherein M multiple polarized signal generating units and M RF units are included, and MN receivers receive different data streams according to corresponding MN polarized signals transmitted by the N polarized signals through each of M transmitting antennas, respectively.

4. The transmitter of claim 1, wherein the multiple polarized signal generating unit calculates and codes a precoder matrix v⁽ⁱ⁺¹⁾=( [symbol] ⁽ⁱ⁾)⁻¹ with respect to the N polarized signals x=(x₁ x₂ . . . x_{N})^{T}, and here [symbol]
⁽ⁱ⁾=(H₁^{T}(w₁⁽ⁱ⁾)*H₂^{T}(w₂⁽ⁱ⁾)* . . . H_{N}^{T}(w_{N}⁽ⁱ⁾)*)^{T}
H₁, H₂, . . . , H_{N} are a channel matrix including line-of-sight and non-line-of-sight channel components with respect to each channel of the N polarized signals, and ω₁⁽ⁱ⁾, ω₂⁽ⁱ⁾, . . . , ω_{N}⁽ⁱ⁾ are a receiving signal combiner column vector having a i-th repeating number with respect to each channel of the N polarized signals.

5. The transmitter of claim 4, wherein the multiple polarized signal generating unit repeatedly calculates the precoder matrix until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here
$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$
Hₘ is a channel matrix for the receiver m, vₘ⁽ⁱ⁺¹⁾ is an m-th column of an i+1-th precoder matrix V⁽ⁱ⁺¹⁾, ( )* is a conjugate complex number, and ∥ ∥₂ is the magnitude of the vector.

6. The transmitter of claim 1, wherein when the M multiple polarized signal generating units and the M RF units are included, each multiple polarized signal generating unit calculates and codes a precoder matrix v⁽ⁱ⁺¹⁾=( [symbol] ⁽ⁱ⁾)⁻¹ with respect to the corresponding MN polarized signals x=(x₁⁽¹⁾x₂⁽¹⁾ . . . x_{N}⁽¹⁾ . . . x₁^{(M)}x₂^{(M)} . . . x_{N}^{(M)})^{T}, and here, [symbol]
⁽ⁱ⁾=( [symbol] ₁^{T}(w₁⁽ⁱ⁾)* [symbol] ₂^{T}(w₂⁽ⁱ⁾)* . . . [symbol] _{MN}^{T}(w_{MN}⁽ⁱ⁾)*)^{T}, [symbol]
₁, [symbol] ₂ . . . , [symbol] _{MN} are a channel matrix including line-of-sight and non-line-of-sight channel components with respect to each channel of the MN polarized signals, and ω₁⁽ⁱ⁾, ω₂⁽ⁱ⁾, . . . , ω_{MN}⁽ⁱ⁾ are a receiving signal combiner column vector having a i-th repeating number with respect to each channel of the MN polarized signals.

7. The transmitter of claim 6, wherein the precoder matrix is repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here
$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$ [symbol]
ₘ is a channel matrix for the receiver m, vₘ⁽ⁱ⁺¹⁾ is an m-th column of an i+1-th precoder matrix V⁽ⁱ⁺¹⁾, ( )* is a conjugate complex number, and ∥ ∥₂ is the magnitude of the vector.

8. A multiple polarized input multiple output method in which respective data streams are transmitted to a plurality of receivers by using multiple polarized signals in a transmitter, the method comprising:
converting and synthesizing N transmission target data streams into N polarized signals; and
up-converting and transmitting the N synthesized polarized signals through a transmitting antenna.

9. The method of claim 8, wherein N receivers receive different data streams according to the N polarized signals transmitted through one transmitting antenna, respectively.

10. The method of claim 8, wherein MN receivers receive different data streams according to corresponding MN polarized signals transmitted by the N polarized signals through each of M transmitting antennas, respectively.

11. The method of claim 8, wherein in the converting and synthesizing step, a precoder matrix v⁽ⁱ⁺¹⁾=( [symbol] ⁽ⁱ⁾)⁻¹ is calculated and coded with respect to the N polarized signals x=(x₁ x₂ . . . x_{N})^{T}, and here [symbol]
⁽ⁱ⁾=(H₁^{T}(w₁⁽ⁱ⁾)*H₂^{T}(w₂⁽ⁱ⁾)* . . . H_{N}^{T}(w_{N}⁽ⁱ⁾)*)^{T}
H₁, H₂, . . . , H_{N} are a channel matrix including line-of-sight and non-line-of-sight channel components with respect to each channel of the N polarized signals, and ω₁⁽ⁱ⁾, ω₂⁽ⁱ⁾, . . . , ω_{N}⁽ⁱ⁾ are a receiving signal combiner column vector having a i-th repeating number with respect to each channel of the N polarized signals.

12. The method of claim 11, wherein the precoder matrix is repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here
$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$
Hₘ is a channel matrix for the receiver m, vₘ⁽ⁱ⁺¹⁾ is an m-th column of an i+1-th precoder matrix V⁽ⁱ⁺¹⁾, ( )* is a conjugate complex number, and ∥ ∥₂ is the magnitude of the vector.

13. The method of claim 1, wherein in order to transmit a total of MN polarized signals by the N polarized signals through the M transmitting antennas, in the converting and synthesizing step, a precoder matrix v⁽ⁱ⁺¹⁾=( [symbol] ⁽ⁱ⁾)⁻¹ is calculated and coded with respect to the corresponding MN polarized signals x=(x₁⁽¹⁾x₂⁽¹⁾ . . . x_{N}⁽¹⁾ . . . x₁^{(M)}x₂^{(M)} . . . x_{N}^{(M)})^{T}, and here, [symbol]
⁽ⁱ⁾=( [symbol] ₁^{T}(w₁⁽ⁱ⁾)* [symbol] ₂^{T}(w₂⁽ⁱ⁾)* . . . [symbol] _{MN}^{T}(w_{MN}⁽ⁱ⁾)*)^{T}, [symbol]
₁, [symbol] ₂, . . . , [symbol] _{MN} are a channel matrix including line-of-sight and non-line-of-sight channel components with respect to each channel of the MN polarized signals, and ω₁⁽ⁱ⁾, ω₂⁽ⁱ⁾, . . . , ω_{MN}⁽ⁱ⁾ are a receiving signal combiner column vector having an i-th repeating number with respect to each channel of the MN polarized signals.

14. The method of claim 13, wherein the precoder matrix is repeatedly calculated until the repeating number i becomes a predetermined number or until a predetermined error value ε satisfies ∥ωₘ⁽ⁱ⁺¹⁾−ωₘ⁽ⁱ⁾∥₂<ε based on the receiving signal combiner column vector ωₘ⁽ⁱ⁺¹⁾ in the corresponding receiver m, and here
$${w}_{m}^{( i + 1 )} = \frac{{( {H}_{m} {v}_{m}^{( i + 1 )} )}^{*}}{{‖ {H}_{m} {v}_{m}^{( i + 1 )} ‖}_{2}} ,$$ [symbol]
ₘ is a channel matrix for the receiver m, vₘ⁽ⁱ⁺¹⁾ is an m-th column of an i+1-th precoder matrix V⁽ⁱ⁺¹⁾, ( )* is a conjugate complex number, and ∥ ∥₂ is the magnitude of the vector.
